(19) United States
(12) Patent Application Publication
(10) Pub. No.: US 2016/0195217 A1
(43) Pub. Date: Jul. 7, 2016

(54) METHOD AND APPARATUS FOR RELEASABLY ATTACHING TOWELS WINDOW COVERINGS WINDOW TREATMENTS CLOTHING RUGS BATHROOM FIXTURES AND ACCESSORIES KITCHEN FIXTURES AND ACCESSORIES CLOSET FIXTURES AND ACCESSORIES PAPER TOWELS TOILET TISSUE FABRICS AND THE LIKE TO A SURFACE

(71) Applicants: Hazel Gerry Flynn-Parkison, Spokane, WA (US); Ralph Francis Parkison, II, Spokane, WA (US)

(72) Inventors: Hazel Gerry Flynn-Parkison, Spokane, WA (US); Ralph Francis Parkison, II, Spokane, WA (US)

(73) Assignee: MagnaJazz LLC, Spokane, WA (US)

(21) Appl. No.: 14/590,003

(22) Filed: Jan. 6, 2015

(51) Int. Cl. F16M 13/02; A47G 29/00; A47B 61/00; A47K 10/04; A47H 1/14

(52) U.S. Cl. CPC F16M 13/022; A47K 10/04; A47H 1/14; A47B 61/003; A47G 29/00

(57) ABSTRACT

A method and apparatus for releasably attaching towels, window coverings, window treatments, clothing, rugs, bathroom fixtures and accessories, kitchen fixtures and accessories, closet fixtures and accessories, paper towels, toilet tissue, fabrics, and the like to a surface.

### BACKGROUND

Most towel racks, towel bars, and drapery rods are horizontal, therefore, towels, clothing, draperies, and the like cannot hang at different heights and angles, individually, and securely. Towels tend to not hang neatly after drying hands using a towel ring, towel hook, towel rack, or towel bar and may fall to the floor or countertop. It may be desirable to hang towels, clothing, draperies, and the like at different heights and angles to provide easy access for children and adults and for aesthetic appeal. In addition, the look and style of towel rings, towel hooks, towel racks, towel bars, and drapery rods are not easily changed since this requires uninstalling mounting devices for the old towel ring, towel hook, towel rack, towel bar, or drapery rod and installing new mounting devices for the new towel ring, towel hook, towel rack, towel bar, or drapery rod. Some towel bar or drapery rod solutions require a metal door or metal wall in order to attach to a surface, and therefore have limited use in most bathrooms and homes.

### SUMMARY

The above problems are solved by releasably attaching towels, window coverings, window treatments, clothing, rugs, bathroom fixtures and accessories, kitchen fixtures and accessories, closet fixtures and accessories, paper towels, toilet tissue, fabrics, and the like to a wall or other surface at a plurality heights and angles by sandwiching towels, window coverings, window treatments, clothing, rugs, bathroom fixtures and accessories, kitchen fixtures and accessories, closet fixtures and accessories, paper towels, toilet tissue, fabrics, and the like between one or more releasably attached or attracted objects at least one of which is attached to a surface which may be but not limited to a wall. The releasably attached or attracted objects are attached or attracted to each other by a holding force. The holding force may be but not limited to magnetic energy, spring energy, friction, mechanical energy, or chemical fastening. Releasably attached or attracted objects of a plurality of sizes and shapes allow placement at a plurality of heights and angles, individually, or in groups which enable towels, window coverings, window treatments, clothing, rugs, bathroom fixtures and accessories, kitchen fixtures and accessories, closet fixtures and accessories, paper towels, toilet tissue, fabrics, and the like to hang in unique designs and arrangements. In addition, towels, clothing, and the like can hang in confined areas to optimize space. Sandwiching towels and the like between one or more releasably attached or attracted objects provides a more secure attachment to a surface than towel rings, towel hooks, towel racks, and towel bars so towels and the like hang neatly after use and are less likely to fall to the floor or countertop. The look and style of window coverings, window treatments, bathroom fixtures and accessories, kitchen fixtures and accessories, closet fixtures and accessories, and the like can be easily changed by replacing one or more of the releasably attached or attracted objects. Attaching one or more of the releasably attached or attracted objects to a surface allows towels, window coverings, window treatments, clothing, rugs, bathroom fixtures and accessories, kitchen fixtures and accessories, closet fixtures and accessories, paper towels, toilet tissue, fabrics, and the like to be releasably attached or attracted to a plurality of surface types which may be, but not limited to non-metallic surfaces.

The method and apparatus will be understood and other features and advantages will become apparent with reference to the attached drawings which show non-limiting examples.

### DRAWINGS—FIGURES

FIG. 1 is a left side view of the apparatus.

FIG. 2 is a left perspective view of the apparatus.

FIG. 3 is a front view of the apparatus used to releasably attach a drapery to a surface.

FIG. 4 is a front view of the apparatus used to releasably attach towels at different heights and angles to a surface.

FIG. 5 is a front view of the apparatus used to releasably attach a towel bar to a surface.

### DRAWINGS—REFERENCE NUMERALS

11 mount object

12 grasping object

### DETAILED DESCRIPTION

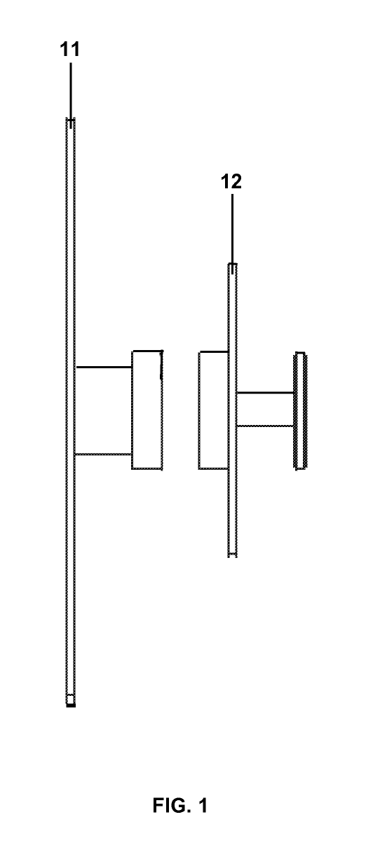

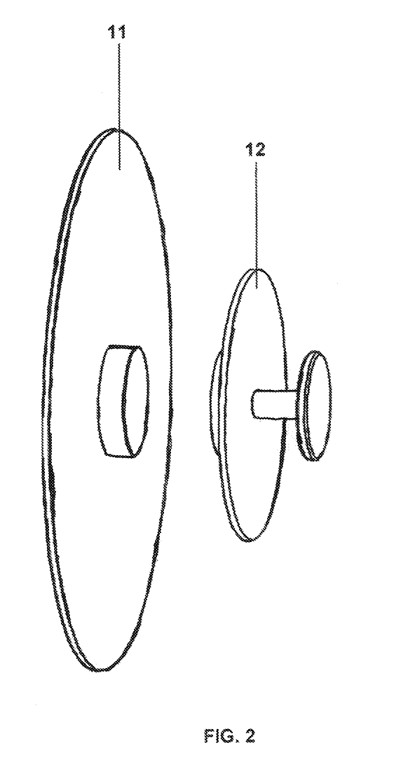

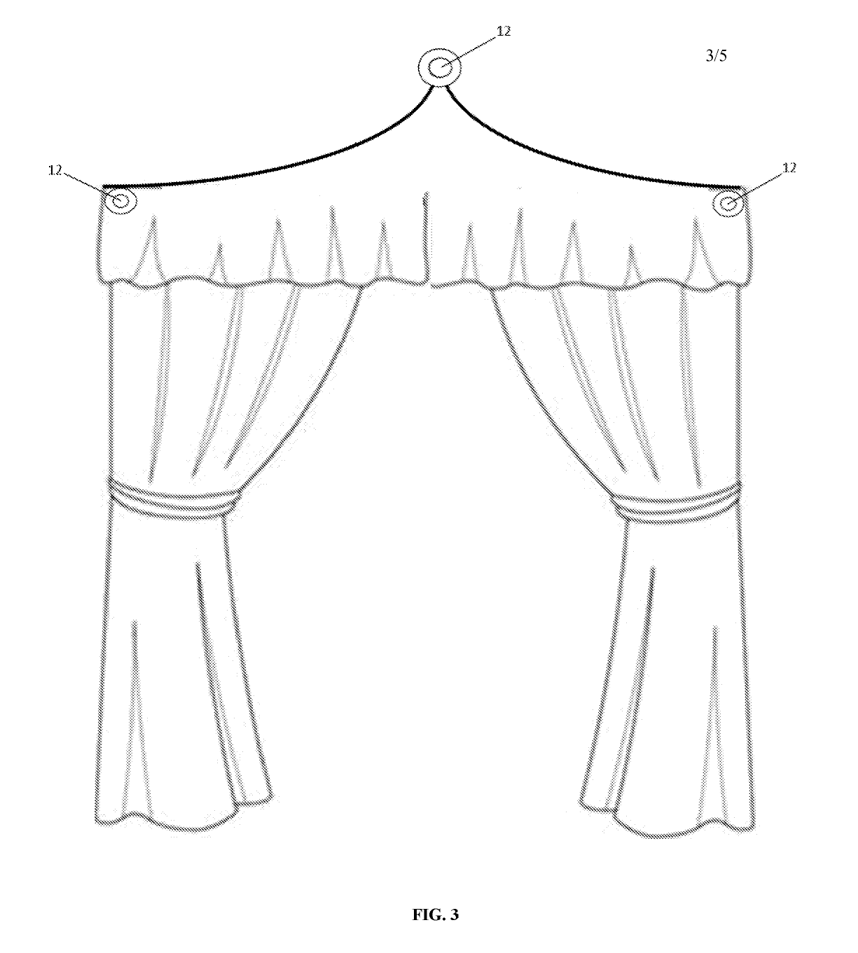

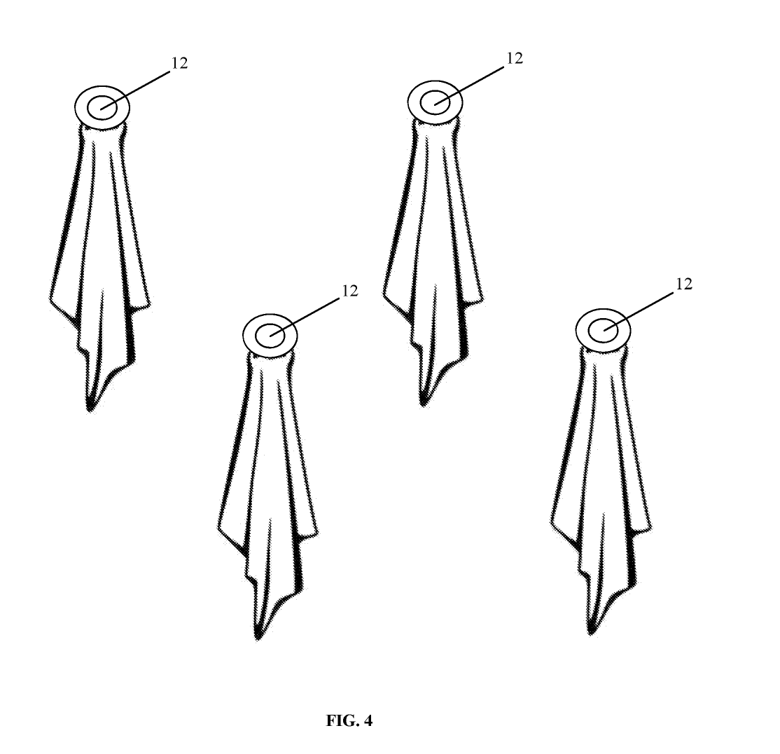

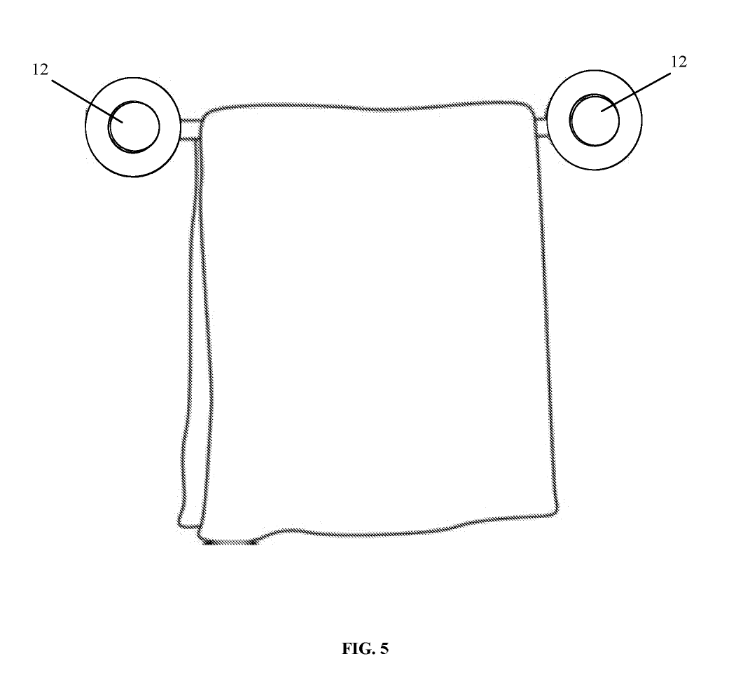

Embodiments are directed to methods and apparatus for releasably attaching towels, window coverings, window treatments, clothing, rugs, bathroom fixtures and accessories, kitchen fixtures and accessories, closet fixtures and accessories, paper towels, toilet tissue, fabrics, and the like to walls or other surfaces at a plurality heights and angles by sandwiching towels, window coverings, window treatments, clothing, rugs, bathroom fixtures and accessories, kitchen fixtures and accessories, closet fixtures and accessories, paper towels, toilet tissue, fabrics, and the like between one or more releasably attached or attracted objects which may or may not also be semi-permanently or permanently attached. As shown in FIG. 1 and FIG. 2, attaching the mount object 11 at a plurality of heights and angles to a wall or other surface. Placing towels, window coverings, window treatments, clothing, rugs, bathroom fixtures and accessories, kitchen fixtures and accessories, closet fixtures and accessories, paper towels, toilet tissue, fabrics, and the like contiguous to mount object 11. Placing the grasping object 12 contiguous to the towels, window coverings, window treatments, clothing, rugs, bathroom fixtures and accessories, kitchen fixtures and accessories, closet fixtures and accessories, paper towels, toilet tissue, fabrics, and the like so towels, window coverings, window treatments, clothing, rugs, bathroom fixtures and accessories, kitchen fixtures and accessories, closet fixtures and accessories, paper towels, toilet tissue, fabrics, and the like thus sandwiching them between mount object 11 and grasping object 12 so that towels, window coverings, window treatments, clothing, rugs, bathroom fixtures and accessories, kitchen fixtures and accessories, closet fixtures and accessories, paper towels, toilet tissue, fabrics, and the like are releasably attached to a wall or other surface at a plurality heights and angles as shown in FIG. 3, FIG. 4, and FIG. 5. The mount object 11 and grasping object 12 are releasably attached or attracted by a holding force which may be but not limited to magnetic energy, spring energy, friction, mechanical energy, or chemical fastening.

While one particular form of the invention has been illustrated and described, it will be apparent that a plurality of modifications, shapes, sizes, and improvements can be made without departing from the spirit and scope of the invention. Accordingly, it is not intended that the invention be limited by the above description.

What is claimed is:

1. A method comprising releasably attaching towels, window coverings, window treatments, clothing, rugs, bathroom fixtures and accessories, kitchen fixtures and accessories, closet fixtures and accessories, paper towels, toilet tissue, fabrics, and the like to a surface by sandwiching said towels, window coverings, window treatments, clothing, rugs, bathroom fixtures and accessories, kitchen fixtures and accessories, closet fixtures and accessories, paper towels, toilet tissue, fabrics, and the like between one or more releasably attached or attracted objects. Said releasably attached or attracted objects can be a plurality of sizes and shapes.

2. The method of claim 1 wherein said releasably attached or attracted objects are attached or attracted using magnetic force.

3. The method of claim 1 wherein said releasably attached or attracted objects are attached or attracted using spring energy.

4. The method of claim 1 wherein said releasably attached or attracted objects are attached or attracted using friction.

5. The method of claim 1 wherein said releasably attached or attracted objects are attached or attracted using mechanical energy.

6. The method of claim 1 wherein said releasably attached or attracted objects are attached or attracted using electricity.

7. The method of claim 1 wherein said releasably attached or attracted objects are attached or attracted using chemical fastening.

8. The method of claim 1 wherein said releasably attached or attracted objects are also semi-permanently or permanently attached.

9. The method of claim 1 wherein said releasably attached or attracted objects are mounted to each other so that one or more of said releasably attached or attracted objects can swing into and out of a plane of one or more of said releasably attached or attracted objects.

10. An apparatus for releasably attaching towels, window coverings, window treatments, clothing, rugs, bathroom fixtures and accessories, kitchen fixtures and accessories, closet fixtures and accessories, paper towels, toilet tissue, fabrics, and the like to a surface comprising one or more objects which are attached to said surface and releasably attached or attracted to itself or one or more said releasably attached or attracted objects. Said releasably attached or attracted objects can be a plurality of sizes and shapes.

11. The apparatus of claim 10 wherein said releasably attached or attracted objects are attached or attracted using magnetic force.

12. The apparatus of claim 10 wherein said releasably attached or attracted objects are attached or attracted using spring energy.

13. The apparatus of claim 10 wherein said releasably attached or attracted objects are attached or attracted using friction.

14. The apparatus of claim 10 wherein said releasably attached or attracted objects are attached or attracted using mechanical energy.

15. The apparatus of claim 10 wherein said releasably attached or attracted objects are attached or attracted using electricity.

16. The method of claim 10 wherein said releasably attached or attracted objects are attached or attracted using chemical fastening.

17. The apparatus of claim 10 wherein said releasably attached or attracted objects are also semi-permanently or permanently attached.

18. The apparatus of claim 10 wherein said releasably attached or attracted objects are mounted to each other so that one or more of said releasably attached or attracted objects can swing into and out of a plane of one or more of said releasably attached or attracted objects.

19. A method comprising releasably attaching towels, window coverings, window treatments, clothing, rugs, bathroom fixtures and accessories, kitchen fixtures and accessories, closet fixtures and accessories, paper towels, toilet tissue, fabrics, and the like to a surface by sandwiching said towels, window coverings, window treatments, clothing, rugs, bathroom fixtures and accessories, kitchen fixtures and accessories, closet fixtures and accessories, paper towels, toilet tissue, fabrics, and the like between one or more releasably attached or attracted objects wherein one or more may be decorative or ornate. Replacing or changing the decorative or ornate design can be easily accomplished by detaching one or more of said one or more releasably attached or attracted objects which may be decorative or ornate and replacing said releasably attached or attracted objects with one or more different releasably attached or attracted objects which may be decorative or ornate.
